(19) United States
(12) Patent Application Publication
(10) Pub. No.: US 2014/0035510 A1
(43) Pub. Date: Feb. 6, 2014

(54) METHODS AND DEVICES FOR CELL-BY-CELL CHARGING OF BATTERY CELLS CONNECTED IN A ROW

(71) Applicant: David Nachman, Bat Yam (IL)

(72) Inventor: David Nachman, Bat Yam (IL)

(21) Appl. No.: 14/004,681

(22) PCT Filed: Mar. 13, 2012
(86) PCT No.: PCT/IL12/00115

§ 371 Date: Oct. 23, 2013

(30) Foreign Application Priority Data
Mar. 14, 2011 (IL) 211716

(51) Int. Cl. H02J 7/00

(52) U.S. Cl. CPC H02J 7/0013
USPC 320/101; 320/107; 320/109; 320/164

(57) ABSTRACT

A device for charging number of cells connected together in a row and create a battery voltage, the charging is done in such a way that every single cell in a battery (or several small cells together) is charged separately by the computer control and moves automatically to the next cell until all cells comprising the battery are full.

### CROSS-REFERENCE TO RELATED APPLICATIONS

This application is a national phase of, and claims priority from, PCT Application No. PCT/IL2012/000115, filed on Mar. 13, 2012, which claims priority from Israel Application No. IL 211716, filed Mar. 14, 2011, both applications of which are hereby incorporated by reference.

### BACKGROUND

An electric battery is a device consisting of one or more electrochemical cells that convert stored chemical energy into electrical energy. Each battery consists of a negative electrode (anode) that holds charged ions, a positive electrode (cathode) that holds discharged ions, an electrolyte that allows ions to move from anode to cathode during discharge (and return during recharge) and terminals that allow current to flow out of the battery to perform work.

### BRIEF SUMMARY

One exemplary embodiment of the disclosed subject matter is an apparatus for charging number of cells of a battery, the apparatus comprising: a charging system; the charging system being adapted for charging every single cell in the battery separately; the charging system being further adapted for being moved automatically to the next cell until all cells comprising the battery are full; and a central computer configured for commanding the charging system to charge and for switching mode of the battery from providing energy to load mode to charging mode; wherein the charging system consumes low-power; thereby providing a straight voltage energy source that provides energy in a continuous way and without limitation. According to some embodiments the central computer is further configured for switching mode of a second battery from a charging mode to providing energy to load mode; thereby providing a continuous energy to load. According to some embodiments the charging system being operated by one member of a group consisting of gasoline, gas, solar, and wind turbine. According to some embodiments the charging system being operated by a solar cell. According to some embodiments the central computer is further configured for commanding the charging system to charge as a result of detecting low power in the battery. According to some embodiments the battery being active as an energy supplier prior to the detecting the low power in the battery and further comprising a replacement switch for activating a second buttery as an energy supplier and for changing the battery mode to a standby mode as a result of the detecting the low power in the battery; thereby providing continuous charging utilizing the low charging system. According to some embodiments the apparatus being used for charging a vehicle.

One exemplary embodiment of the disclosed subject matter is a charging method the charging method comprising: detecting low power in a battery; commanding a charging system for charging every sing le cell in the battery separately until all cells comprising the battery are full; and switching a mode of the battery from providing energy to load mode to charging mode; wherein the charging system consumes low-power; thereby providing a straight voltage energy source that provides energy in a continuous way and without limitation. According to some embodiments the method further comprising activating a second buttery as an energy supplier and for changing the battery mode to a standby mode as a result of the detecting the low power in the battery; thereby providing continuous charging utilizing the charging system wherein the charging system consumes low-power.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a block diagram of a charging system with 2 batteries, in accordance with some exemplary embodiments of the subject matter; and

FIG. 2 shows a block diagram of a charging system with three batteries, in accordance with some exemplary embodiments of the disclosed subject matter.

### DETAILED DESCRIPTION

Methods and devices for charging a number of cells connected together in a row and create a certain battery voltage.

The charging method is done in such a way that every single cell (or several small cells together) is charged separately by the charging system and supervised by a central computer 106, after the charge of each cell separately (or a small number of cells together) is finished, the charging system automatically moves to the next cell (or a small number of cells together) and does the following charge in the serial, until all the cells that make up the full battery are charged. After the charge is finished, the charging system turns off and this battery enters into a standby mode.

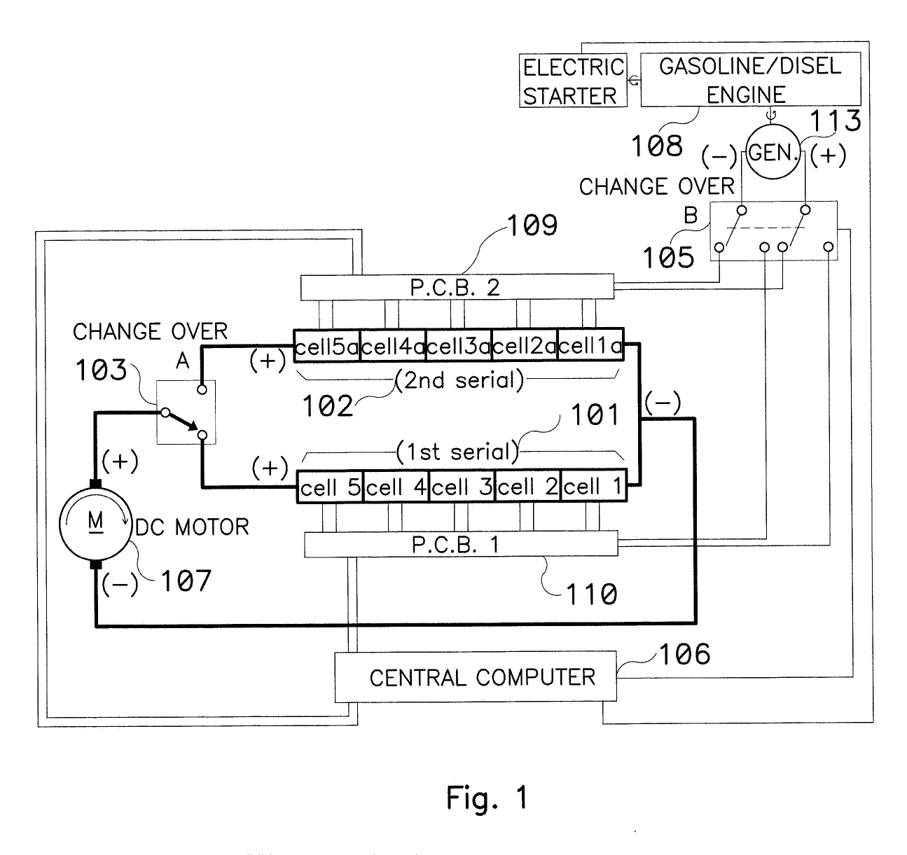

FIG. 1 shows a block diagram of a charging system with 2 batteries, in accordance with some exemplary embodiments of the subject matter

This charging method is suitable for combined systems, when one battery 1st serial 101 (cell 1÷cell 5) (consisting of several cells as explained above) is working and provides energy to the required load (consumer), and an additional battery or more 2nd serial 102 (cell 1a÷cell 5a) is in standby mode so that once that 1st serial 101 is low, a command to switch between the batteries 1st serial 101 and 2nd serial 102 is automatically sent (by the central computer 106). Once the batteries were replaced, the situations have changed—2nd serial 102 becomes the battery that provides the energy to the load (consumer), and 1st serial 101 begins to charge by the charging method explained above, and the charging system gets an operating command from the central computer 106.

At this method, by the charging system that consists of gasoline, gas, diesel engine, air turbine, an alternator (current search) connected to it in a significantly low-power, you can create a straight voltage energy source that provides energy in a continuous way and without limitation, but only if the complex is planned correctly and according the laws of electricity.

This method can be implemented in many applications, each application is given the options to refine, add or subtract additional methods in additional energies such as solar, wind, etc. to help the method explained above to work better, take advantage of natural energy and by this save energy in the shown system.

The method (charging system) is required for charging batteries that are connected together in a parallel. Every battery consists from number of cells connected together in a serial cell by cell.

The number of cells in a serial is dictated by demands of system that is required for starting equipment in DC voltage.

For example: DC motors 107—BRASS or BRASSLES and etc. To explain you this point I'm giving you as example existing battery types (and future batteries, when the voltage of each cell in the battery is different).

Voltage

Battery consists of number of cells joined together. Each cell has its' voltage that depends of the material type it's made of.

Batteries:

| | | |
|---|---|---|
| 1. | Battery Lead acid | voltage of every single cell is 2 V |
| 2. | Battery NiCad/NiMH | voltage of every single cell is 1.2 V |
| 3. | Battery Lithium | voltage of every single cell is 3.6 V |

For example, nowadays, batteries connected in a serial that their general voltage is ranged from 12V to 400V and more, are used in types of electric vehicles.

To get such voltage, number of cells should be joined into a serial. For example, to get 36V there should be:

| | |
|---|---|
| 18 × 2 | cells of Lead acid battery |
| 30 × 1.2 | cells of NiCad/NiMH battery |
| 10 × 3.6 | cells of Lithium battery |

Hour Ampere (H/A)

Hour Ampere is the batteries' capacity of electric energy. It means—how much electric current the battery can provide in an hour. For example: 10 H/A 24V battery can provide 10 A for an hour or current of 5 A for 2 hours.

Of course, it's only a theory because the batteries' reaction is not linear.

The formula for electric power is the multiply of current by voltage.

W=I×V

I=electric current

V=voltage

W=power

For example: Set of 12 A, 24V battery contains 288 W. Set of 8 A, 36V battery also contains 288 W.

In theory, the result must be the same if the work is in same conditions.

Referring now to the FIG. 1, the method is required for charging batteries that are connected in a parallel and one battery provides energy for equipment and systems that work in DC voltage 1st serial 101 (cell 1÷cell 5), on the contrary the second battery 2nd serial 102 (cell 1a÷cell 5a) are in charge cell by cell until the last cell in the serial is finally charged (cell 5a).

This method does for 1 couple of batteries or more.

In my explanation of the method I use as example only 1 couple of batteries—1st serial 101 and 2nd serial 102 as a basic system.

The charging system is operated by gasoline, gas (diesel) engine, wind turbine and the alternator connected to it and fitted to the cells' size existing in the battery system. The gasoline, gas (diesel) engine 108 and the alternator are significantly low-powered because the charging power is low, and the reason is that only single one cell is in charging (or several small cells together).

Once the charging system has finished charging the battery 2nd serial 102, central computer 106 gives shut down command to gasoline, gas (diesel) engine, and the alternator attached to it stops working, battery 2nd serial 102 enters into standby mode. Battery 1st serial 101 continues to provide current to equipment and systems connected to it, the central computer 106 continuously samples the voltage and capacity of this battery, until permitted depletion condition, at this moment the central computer 106 sends a replacement command by replacement switch Change Over A 103 and Change Over B 105 simultaneously (together), charged battery 2nd serial 102 that was in standby mode, becomes an energy supplier for equipment and systems, and battery 1st serial 101 gets into charge, gasoline, gas (diesel) engine gets operating command and the alternator begins to charge the battery cell after cell as mentioned earlier. Loading and unloading cycle is a function to the amount of battery energy that is used as a current provider to equipment and systems that work in DC voltage.

At rest, when the system does not work (load or consumer not connected) this method can be perfected by a suitable solar cell instead of the existing alternator that is connected to the entrance P.C.B 2 104 for charging battery 2nd serial 102 that is in standby mode, for charging in the same charging method explained above, meaning continue of charging battery 2nd serial 102 cell after cell until the last cell in column is charged (cell 5a).

### Example for Solution 1

Parked vehicle, that is installed as explained by the charging system as explained above, on a sunny day, with the addition of a solar cell installed properly on the roof of the vehicle is a solution (add) for charging the battery (that is in standby mode and did not finish the loading of all cells that comprise it) cell after cell until the last cell is charged perfectly. It is possible, that at the end of the last cell charging in cell the column, the solar cell will return back to the first cell and charge again cell after cell in a cycle.

This form of charging by the solar cell we get a perfect charge for the battery every time the vehicle is parked. Once the vehicle starts moving, solar system is disconnected from the charging system.

### Example for Solution 2

It is also possible to refine this charging system with air turbine (Turbo). While the vehicle is travelling over a certain speed (battery powered vehicle with a charging system according to the explanation above). The addition of air turbine helps to get additional power (wind energy) to gasoline, gas (diesel) engine to turn the alternator that charges the battery while it is in a standby mode, in the charging system. Using this supplement we save and use natural energy while saving energy that runs the gasoline, gas (diesel) engine, and gas saving.

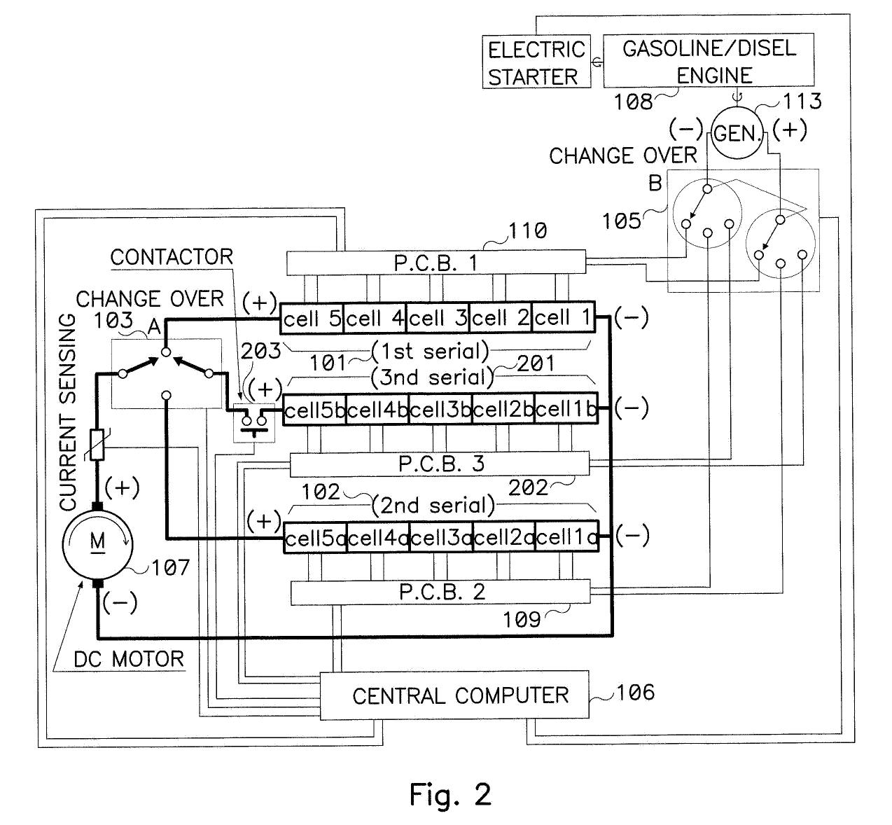

FIG. 2 shows a block diagram of a charging system with three batteries, in accordance with some exemplary embodiments of the disclosed subject matter.

The method is required for charging batteries that are connected in a parallel so that one battery provides energy to systems that work in DC voltage, as explained, in addition of a third battery 3rd serial (cell 1b÷cell 5b) 201.

This method is suitable for 3 or more batteries.

The explanation on FIG. 1 is similar to this method, only with an addition of a third battery 3rd serial 201 that connects through a touch (contactor 203) by sensing current (current sense) that is connected in a line or by inductive to the load, consumer and so on.

As soon as the current sensing reaches a certain level (stated by the systems' planning), battery 3rd serial 201 gets into parallel connection (parallel) with battery 1st serial 101 by a touch that is operated by current sensing. The parallel connection of battery 3rd serial 201 to battery 1st serial 101 occasionally, 15 extends the time use of battery 1st serial 101 that is used to supply energy to equipment and systems that work in DC voltage. Extension of time to limit battery 1st serial 101, allows to battery 2nd serial 102 that is being charged, to finish the load and transport it to the standby mode.

The central computer 106 of the system constantly samples the tension and electrical capacity of the 3 batteries, and once the replacement command is done battery 1st serial 101 is empty, the computer activates the replacement switch Change Over A 103 and Change Over B 103, battery 1st serial 101 gets into charging mode, battery 2nd serial connects to the load (consumer) together with port (+) in contact (contactor 203).

Battery 3rd serial 201 is not empty yet, it joins occasionally in a parallel way to battery 2nd serial 102 that is used to supply energy to the load (consumer). Battery 1st serial 101 is in charge until it is full and then switches to standby mode. Once battery 3rd serial 301 is empty, the computer locks the contact (contactor 203) to prevent this battery (3rd serial) 301 to connect in a parallel to battery 2nd serial 202, the computer gives a command to the replacement switch Change Over B to change the mode, and battery 3rd serial gets into charging mode. If through this process battery 2nd serial 102 gets empty, the computer begins to load 2nd serial. Replaces between battery 2nd serial 102 and 1st serial 101 that was in standby mode, battery 3rd serial continues to load, and at the end it returns to the initial state, and battery 2nd serial 102 gets into charge.

The whole process is under control and supervision by the central computer 106. Description presented in FIG. 1, FIG. 2 is intended for illustration purposes only, of course, in planning this kind of charging systems there should be used modem components of existing advanced technologies in the world today such as: Solid State Relay, Power Mosfet and more.

The invention being thus described in terms of embodiments and examples, it will be obvious that the same may be varied in many ways. Such variations are not to be regarded as a departure from the spirit and scope of the invention, and all such modifications as would be obvious to one skilled in the art are intended to be included within the scope of the claims.

What is claimed is:

1-8. (canceled)

9. An apparatus for charging cells of a battery, the apparatus comprising:
(a) a charging system; said charging system being adapted for charging every single cell in said battery separately ; said charging system being further adapted for being moved automatically to the next cell until all cells comprising the battery are full; and
(b) a central computer configured for commanding said charging system to charge and for switching mode of said battery from providing energy to load mode to charging mode; wherein said charging system consumes low-power; thereby providing a straight voltage energy source that provides energy in a continuous way and without limitation.

10. The apparatus according to claim 9, wherein said central computer is further configured for switching mode of a second battery from a charging mode to providing energy to load mode; thereby providing a continuous energy to load.

11. The apparatus according to claim 9, wherein said charging system being operated by one member of a group consisting of gasoline, gas, solar, and wind turbine.

12. The apparatus according to claim 9, wherein said charging system being operated by a solar cell.

13. The apparatus of claim 9, wherein said central computer is further configured for commanding said charging system to charge as a result of detecting low power in said battery.

14. The apparatus of claim 9, wherein said battery being active as an energy supplier prior to said detecting said low power in said battery and further comprising a replacement switch for activating a second battery as an energy supplier and for changing said battery mode to a standby mode as a result of said detecting said low power in said battery; thereby providing continuous charging utilizing said low charging system.

15. The apparatus of claim 9; wherein said apparatus being used for charging a vehicle.

16. A charging method said charging method comprising:
(a) detecting low power in a battery;
(b) commanding a charging system for charging every single cell in said battery separately until all cells comprising the battery are full; and
(c) switching a mode of said battery from providing energy to load mode to charging mode; wherein said charging system consumes low-power; thereby providing a straight voltage energy source that provides energy in a continuous way and without limitation.

17. The charging method of claim 16, further comprising activating a second battery as an energy supplier and for changing said battery mode to a standby mode as a result of said detecting said low power in said battery; thereby providing continuous charging utilizing said charging system wherein said charging system consumes low-power.
